(19) United States
(12) Patent Application Publication
(10) Pub. No.: US 2009/0063589 A1
(43) Pub. Date: Mar. 5, 2009

(54) APPARATUS AND METHOD TO DECOUPLE LARGE OBJECT DATA PROCESSING FROM MAIN-LINE DATA PROCESSING IN A SHARED-NOTHING ARCHITECTURE

(75) Inventors: Philip S. Cox, Thornhill (CA); Leo T. M. Lau, Thornhill (CA); Adil M. Sardar, Markham (CA); David Tremaine, Markham (CA)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/847,306

(22) Filed: Aug. 29, 2007

(51) Int. Cl. G06F 17/30

(52) U.S. Cl. 707/205; 707/E17.001

(57) ABSTRACT

An apparatus and method to to decouple large object (“LOB”) data processing from main-line data processing in a shared-nothing architecture. The method may include relocating rows in a database table from a source partition to a target partition, where each row stores a source descriptor identifying a LOB associated with the row. The source descriptors may be read, and space sufficient to store each LOB in a target repository may be allocated accordingly. Source descriptors may be extracted from the rows, and sorted according to the location of the LOBs in the source repository to provide an ordered retrieval sequence. Each LOB may be retrieved from the source repository according to the retrieval sequence, and stored in its allocated space. The source descriptor stored in each row in the target partition may then be replaced with a target descriptor to identify the location of the respective LOB in the target repository.

### BACKGROUND OF THE INVENTION

1. Field of the Invention

The invention relates to database systems. Particularly, the invention relates to facilitating large object data processing in a shared-nothing architecture.

2. Description of the Related Art

As consumers have become more demanding in requiring quick and efficient service from businesses, companies have been quick to find ways to stay ahead of the competition. Business intelligence applications and technologies are one method by which companies may make more informed business decisions and cater to consumer needs and expectations. Such applications are used to analyze performance, projects, or internal operations, as well as to extrapolate information from indicators in the external environment to forecast future needs.

As business intelligence applications require an accumulation of data over time, adequate storage capacity is paramount to proper application performance. Shared-nothing architecture is a popular structure for such systems because of its scalability. This architecture enables support for very large databases by dividing the database into partitions that can be stored and managed on separate servers. Elapsed time for queries may also be drastically reduced by enabling individual queries to be processed in parallel.

In an existing shared-nothing system, storage and processing power may be easily increased or decreased by adding or removing physical machines to meet present or projected future needs. In such an event, data ownership must be changed and existing data redistributed. Data redistribution may also be required where existing data is not evenly distributed across physical hardware components, or does not meet business requirements.

Data redistribution operations may present particular problems where large object (“LOB”) data, such large blocks of text, graphic images, videos, sound files, and the like, is involved. Particularly, the potentially large size of LOB data may dramatically hinder system performance where such data must be moved from one partition to another. Indeed, while a typical row in a database table may store only a few hundred bytes of non-LOB data, a single LOB may be on the order of multiple gigabytes in size.

Traditional data processing proceeds serially from row to row. Further, LOB processing operations are coupled to data processing operations. As a result, data processing and redistribution may be interrupted and temporarily suspended pending relocation of a LOB associated with a particular row. This time required to move the LOB from one storage location to another often results in substantial data processing delays and other performance costs.

In addition, a large number of disk I/Os are typically needed to move LOBs from one partition to another. A single LOB may be divided across multiple storage locations within a single partition and thus require a large number of disk I/Os to sequentially move the various pieces to the new partition. Similarly, multiple LOBs having various storage locations within a single partition may be sequentially accessed and moved based on their associated row positions in the database table rather than according to their storage locations. This may result in numerous random I/Os to read and write such LOBs from their existing storage locations to their new locations. Such random I/O patterns consume substantial amounts of time and resources, and thus negatively impact system dynamics.

From the foregoing discussion, it should be apparent that a need exists for an apparatus and method to decouple LOB data processing from main-line data processing in a shared-nothing architecture. Beneficially, such an apparatus and method would reduce inefficiencies and costs traditionally associated with relocating a LOB from one database partition to another in connection with data redistribution operations. Such an apparatus and method are disclosed and claimed herein.

### SUMMARY OF THE INVENTION

The present invention has been developed in response to the present state of the art, and in particular, in response to the problems and needs in the art that have not yet been met for decoupling large object data processing from main-line data processing in a shared-nothing architecture. Accordingly, the present invention has been developed to provide an apparatus and method for decoupling large object data processing from main-line data processing in a shared-nothing architecture that overcomes many or all of the above-discussed shortcomings in the art.

An apparatus to decouple large object (“LOB”) data processing from main-line data processing in a shared-nothing architecture in accordance with embodiments of the present invention may include a relocation module, an allocation module, a generation module, a transmission module, a sort module, a retrieval module, and a storage module. The relocation module may relocate rows in a database table from a source partition to a target partition. Each row may store a source descriptor that identifies a LOB associated with the row. The source descriptor may also store a length and an offset value identifying a location of the LOB in a source repository.

The allocation module may allocate space sufficient to store the LOB in a target repository. The space may be allocated according to the offset value and length provided by the source descriptor associated with the LOB.

The generation module may generate target descriptors identifying the space allocated for each of the LOBs in the target repository. The transmission module may then transmit descriptor pairs from the target partition to the source partition, where each descriptor pair includes a source descriptor and a target descriptor corresponding to one of the LOBs.

The sort module may sort the descriptor pairs according to the source descriptors to provide a retrieval sequence in order of a storage location of each of the LOBs in the source repository. In this manner, the sort module may limit movement associated with a read/write head. The retrieval module may then retrieve the LOBs from the source repository according to the provided sequence, and the storage module may store each LOB in its allocated space in the target repository.

A method of the present invention is also presented to decouple large object (“LOB”) data processing from main-line data processing in a shared-nothing architecture. In one embodiment, the method includes receiving requests to relocate rows in a database table from a source partition to a target partition. As in the apparatus, each row may store a source descriptor identifying a LOB associated with the row. The source descriptor may store a length and offset value identifying a location of the LOB in a source repository. The rows may be relocated from the source partition to the target partition. The source descriptors may then be read and space sufficient to store each LOB in a target repository may be allocated accordingly.

Target descriptors may be generated to identify the space allocated for each of the LOBs in the target repository. Descriptor pairs, each including a source descriptor and a target descriptor corresponding to each LOB, may then be transmitted from the target partition to the source partition. The descriptor pairs may be sorted according to the source descriptors to provide a retrieval sequence in order of a storage location of each of the respective LOBs in the source respoitory. Such sorting may be performed to limit movement associated with a read/write head. Each LOB may be retrieved from the source repository according to the retrieval sequence, and stored in its allocated space in the target repository.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating modules for decoupling large object data processing from main-line data processing in accordance with embodiments of the present invention; and

FIG. 2 is a high-level schematic block diagram illustrating one embodiment of a process for decoupling large object data processing from main-line data processing in accordance with the present invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Embodiments of the present invention teach an apparatus and method to decouple large object (“LOB”) data processing from main-line data processing in a shared-nothing architecture. As used herein, the term “shared-nothing architecture” refers to a distributed computing architecture where each node is independent and self-sufficient, without the need to directly share memory or disk access. The term “large object” or “LOB” refers generally to large pieces of unstructured data, such as large blocks of text, graphic images, videos, sound files, or the like. LOB data types include binary large objects (“BLOBs”), character large objects (“CLOBs”), and double-byte character large objects (“DBCLOBs”). The term “offset” or “offset value” refers to a number indicating displacement from the beginning of a LOB or other data structure object up to a given element or point.

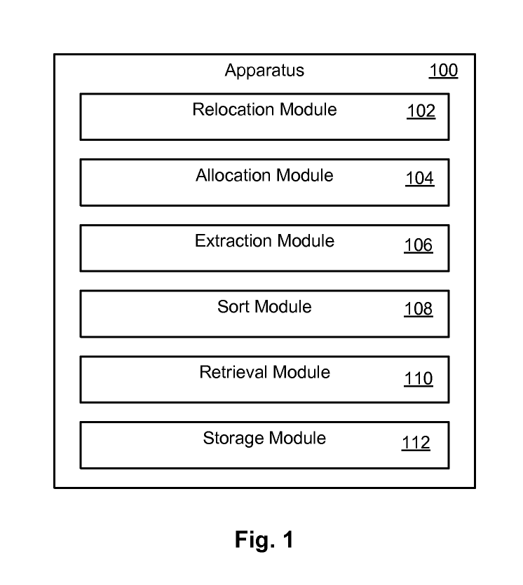

FIG. 1 illustrates one embodiment of an apparatus 100 to decouple large object (“LOB”) data processing from main-line data processing in a shared-nothing architecture. In this type of architecture, one or more databases (not shown) may be partitioned into various database partitions or nodes (not shown). These partitions may be stored and managed on separate servers of the shared-nothing system to enable parallel database searches with reduced query times. Individual servers in the shared-nothing system may communicate with each other over a high-speed, low latency network, such as a system area network (“SAN”).

In some embodiments, databases may present data as a collection of database tables (not shown), where each table includes a defined number of columns, or index keys, and rows. Large object (“LOB”) data may be associated with one or more rows in a database table. Because of its large size, however, LOB data may be stored at a location other than within its associated row to reduce storage requirements for applications that access the LOB, and to facilitate data processing and system performance. Instead, the row may store a LOB descriptor, or host variable, that represents a single LOB in the database partition. The LOB descriptor may contain control information, such as an offset value and length, to allow applications to easily access and/or manipulate the LOB from its storage location within the partition.

Due to its inherently large size, however, moving an LOB into or out of a particular database partition may significantly slow down system performance. Such LOB movement may be required, for example, where associated table data is moved from one location to another. As traditional data processing proceeds serially from row to row, and as LOB processing operations are traditionally coupled to data processing operations, data processing and redistribution may be interrupted and temporarily suspended pending relocation of a LOB associated with a particular row. This time required to move the LOB from one storage location to another often results in substantial data processing delays and other performance costs. Embodiments of the present invention decouple LOB processing from main-line data processing to facilitate efficient, substantially continuous data processing operations.

An apparatus 100 to decouple LOB processing from main-line data processing in accordance with the present invention may include a relocation module 102, an allocation module 104, a generation module 106, a transmission module 107, a sort module 108, a retrieval module 110, and/or a storage module 112. The relocation module 102 may relocate rows in a database table from one partition to another. Particularly, the relocation module 102 may relocate the rows from a source partition to a target partition. Each row may include one or more source descriptors identifying a LOB associated with the row. The LOBs may be stored in a source repository within the source partition. The source descriptors may thus store lengths and offset values, or sets of lengths and offset values, identifying the locations of LOBs in the source repository.

The allocation module 104 may allocate space in a target repository sufficient to store a LOB associated with a relocated row. The target repository may be located within the target partition and associated with a target database table housing the relocated row. Particularly, the allocation module 104 may allocate the space in the target repository based on the source descriptor included in the relocated row, such that the space allocated is greater than or equal to the length stored by the source descriptor.

The generation module 106 may generate target descriptors identifying the space allocated for each of the LOBs in the target repository. Each source descriptor and target descriptor corresponding to a particular LOB may be grouped together to form a descriptor pair. The transmission module 107 may then transmit descriptor pairs from the target partition to the source partition. In some embodiments, the target descriptor may be transmitted back to the target partition to hold the allocated space in the target repository pending relocation of the LOB from the source partition to the target partition, while both the source descriptor and target descriptor may be used within the source partition to aid LOB retrieval and relocation from the source partition to the target partition.

Particularly, the sort module 108 may sort the descriptor pairs according to the source descriptors to provide a retrieval sequence ordered according to the storage locations of each of the identified LOBs in the source repository. For example, the sort module 108 may sort the source descriptors according to their stored offset values. In one embodiment, the sort module 108 sorts the source descriptors in ascending order of associated offset value. In this manner, the sort module 108 may provide a retrieval sequence for the identified LOBs that may be used to minimize movement of the read/write head used to relocate the LOB from the source partition to the target partition.

The retrieval module 110 may retrieve each of the LOBs from the source repository according to the retrieval sequence. In some embodiments, the retrieval module 110 may utilize the offset value identified by the source descriptor to retrieve each of the identified LOBs from the source repository and transmit the LOB to the target partition. The storage module 112 may then store each of the LOBs in its allocated space in the target repository.

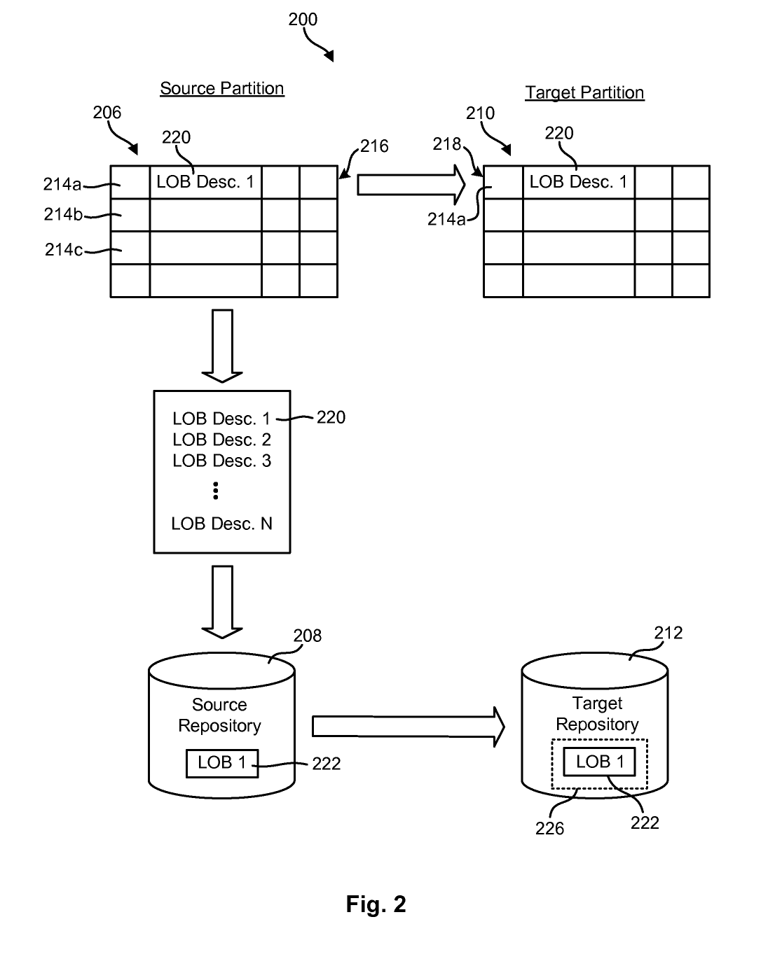

Referring now to FIG. 2, a process 200 for decoupling LOB data processing from main-line data processing in accordance with the present invention may include receiving requests to relocate rows 214 in a database table 206 from a source partition 202 to a target partition 204. Specifically, requests may be received to relocate rows 214 from source locations 216 in a source database table 206 to target locations 218 in a target database table 210. The source database table 206, or source table 206, may be located within the source partition 202, and the target database table 210, or target table 210, may be located within the target partition 204. In one embodiment, for example, a request may mandate deletion of a row 214a from a source location 216 in the source table 206, and insertion of the row 214a at a target location 218 in the target table 210. The row 214a may then be relocated accordingly.

Where the relocated row 214 includes a source descriptor 220 identifying a LOB 222 associated with the row 214, the LOB 222 may be independently relocated from the source partition 202 to the target partition 204. The source descriptor 220 may store a length and offset value, or a set of lengths and offset values, identifying a location of the LOB 222 in a source repository 208. The source repository 208 may be located within the source partition 202 and associated with the source table 206. The information stored by the source descriptor 220 may then be used to allocate a space 226 sufficient to store the LOB 222 in a target repository 212, where the target repository 212 is located within the target partition 204 and associated with the target table 210. The space 226 allocated may be greater than or equal to the length stored by the source descriptor 220.

Upon relocating a row 214 from the source partition 202 to the target partition 204, target descriptors 224 may be generated to identify the space allocated for each of the identified LOBs 222 in the target repository 212.

A target descriptor 224 identifying a particular LOB 222 may be grouped with a source descriptor 220 identifying a storage location of the same LOB 220 in the source partition 202. The resulting descriptor pair 228 may then be transmitted to the source partition 202 for retrieval and relocation purposes. Specifically, in some embodiments, the target descriptor 224 may be transmitted from the source partition 202 to the target partition 204 to be included in the pages written to the target repository 212 prior to relocation of the LOB 222. In this manner, the allocated space 226 may be identified and held pending LOB 222 relocation from the source repository 208 to the target repository 212.

At the source partition 202, descriptor pairs 228 may be sorted according to the source descriptors 220 to provide a LOB 222 retrieval sequence 230 in order of a storage location of each of the respective LOBs 222 in the source repository 208. The source descriptors 220 may be sorted by stored offset values and each LOB 222 may be retrieved from the source repository 208 at the offset value identified by the source descriptor 220, according to the retrieval sequence 230. In this manner, embodiments of the present invention may improve I/O characteristics associated with reading and writing LOBs 222 from the source repository 208 to the target repository 212. Specifically, embodiments of the present invention may read and write LOBs 222 from the source repository 208 to the target repository 212 in a more linear and continuous fashion, thereby reducing movement of associated read/write heads. Each LOB 222 may then be transmitted from the source partition 202 to the target partition 204 and stored in its allocated space 226 in the target repository 212.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to decouple large object (“LOB”) data processing from main-line: data processing in a shared-nothing architecture, the apparatus comprising:
a relocation module to relocate a plurality of rows in a database table from a source partition to a target partition, each row storing a source descriptor identifying a LOB associated with the row, each source descriptor storing a length and offset value identifying a location of the LOB in a source repository;
an allocation module to allocate a space in a target repository sufficient to store each of the LOBs based on the source descriptor associated therewith;
a generation module to generate target descriptors identifying the space allocated for each of the LOBs in the target repository;
a transmission module to transmit descriptor pairs from the target partition to the source partition, each descriptor pair comprising a source descriptor and a target descriptor corresponding to one of the LOBs;
a sort module to sort the descriptor pairs according to the source descriptors to provide a retrieval sequence in order of a storage location of each of the respective LOBs in the source repository;
a retrieval module to retrieve each of the LOBs from the source repository according to the retrieval sequence; and
a storage module to store each of the LOBs in its allocated space in the target repository.

2. The apparatus of claim 1, wherein the sort module sorts the descriptor pairs according to the source descriptors to limit movement associated with a read/write head.

3. A method to decouple large object (“LOB”) data processing from main-line data processing in a shared-nothing architecture, the method comprising:
receiving requests to relocate a plurality of rows in a database table from a source partition to a target partition, each row storing a source descriptor identifying a LOB associated with the row, each source descriptor storing a length and offset value identifying a location of the LOB in a source repository;
relocating the rows from the source partition to the target partition;
reading the source descriptors and allocating a space in a target repository sufficient to store each of the LOBs;
generating target descriptors identifying the space allocated for each of the LOBs in the target repository;
transmitting, from the target partition to the source partition, descriptor pairs, each descriptor pair comprising a source descriptor and a target descriptor corresponding to one of the LOBs;
sorting the descriptor pairs according to the source descriptors to provide a retrieval sequence in order of a storage location of each of the respective LOBs in the source repository;
retrieving each of the LOBs from the source repository according to the retrieval sequence; and
storing each of the LOBs in its allocated space in the target repository.

4. The method of claim 3, wherein sorting the descriptor pairs according to the source descriptors is performed to limit movement associated with a read/write head.
